(19) United States
(12) Patent Application Publication
(10) Pub. No.: US 2013/0304657 A1
(43) Pub. Date: Nov. 14, 2013

(54) LOCATION-BASED CONNECTION SYSTEM FOR REAL ESTATE AGENTS AND CLIENTS THEREOF

(71) Applicants: Todd Miller, Las Vegas, NV (US); Oana Sterlacci, Las Vegas, NV (US)

(72) Inventors: Todd Miller, Las Vegas, NV (US); Oana Sterlacci, Las Vegas, NV (US)

(21) Appl. No.: 13/468,563

(22) Filed: May 10, 2012

(51) Int. Cl. G06Q 50/16

(52) U.S. Cl. 705/313

(57) ABSTRACT

A connection system configured to connect real estate agents and clients based on their relative locations allows rapid deployment of real estate services, such as property viewings. The connection system may include one or more connection servers, agent access devices, and client access devices. A set of nearby agents may be determined based on a client's location. The nearby agents that are available to provide a showing of the client's desired property may be presented to the client for selection. The system may provide identification, biographical, and professional experience information to the client to allow an informed selection. A selected agent may the confirm his or her availability and proceed to show the property to the client.

### BACKGROUND OF THE INVENTION

1. Field of the Invention

The invention relates to service provider listing services, and in particular to a location-based connection system for real estate agents and their clients.

2. Related Art

Traditionally, those seeking professional services have used static listings, such as telephone books or online or other directories to find service providers. Service seekers in finding service providers have also used referrals, either professional or informal.

It has become possible to locate service providers based on their location. For example, a service seeker may search for particular types of service providers based on their location relative to the service seeker's location. However, these search services work only for the fixed business location of these service providers.

With recent developments to technology, it has become possible to locate a mobile service providers based on their location. For example, with regard to transportation services, some dispatch services automatically assign the closest mobile service provider to a service seeker with the goal of providing the fastest possible service.

From the discussion that follows, it will become apparent that the present invention addresses the deficiencies associated with the prior art while providing numerous additional advantages and benefits not contemplated or possible with prior art constructions.

### SUMMARY OF THE INVENTION

A connection system for facilitating location-based connections of real estate agents and clients is disclosed herein. The connection system allows agents within a vicinity of a client to be quickly and easily located. Both agents and clients are provided the option to approve one another for a property showing/viewing. In addition, since the connection system is location-based, real estate services can be conveniently obtained wherever the client finds a property he or she is interested in.

The connection system may have various embodiments as is disclosed herein. For instance, in one exemplary embodiment a real estate agent and client connection system is provided. Such a system may comprise one or more agent access devices configured to determine and transmit the location of one or more real estate agents, a client access device configured to transmit one or more requests to view a property, and a connection server. The request may include location data specifying the location of a client and property data describing the property.

The connection server may be configured to store identification data for the real estate agents and the client, store property data received from the client access device, and maintain an updated record of the location data of the real estate agents. In response to the requests, identification data identifying one or more nearby agents based on the location of the real estate agents relative to the location of the client may be transmitted to a client access device. The nearby agents may be displayed on a display screen of the client access device.

The connection server may also receive a showing proposal from one or more of the nearby agents identifying. The showing proposal may identify those one or more nearby agents as available agents. The connection server may also receive a client confirmation from the client access devices identifying one of the available agents. This confirms the client's desire to view a property with the identified available agent. It is noted that the connection server may be further configured to receive an agent confirmation from the identified available agent. The agent confirmation would confirm the agent's availability to show the property.

The client access device may be configured to retrieve from the connection server and display identification information associated with the available agents. In addition, the client access device may be configured to retrieve location data identifying the location of the available agents from the connection server and to display the retrieved location data on a map.

Similarly, the agent access devices may be configured to retrieve at least some of the property data from the connection server and to present the retrieved property data to the nearby agents. In addition, the agent access devices may be configured to retrieve location data identifying the location of the client from the connection server and to display the retrieved location data on a map. The agent access devices may also retrieve identification data about the client from the connection server and to display the retrieved identification data to the nearby agents.

In another exemplary embodiment, a connection server may be provided. Such a connection server may comprise one or more storage devices configured to store identification data for one or more agents and one or more clients, and property data. The connection server may also include one or more communication devices and one or more processors.

The communication devices may be configured to receive location data identifying a location of the agents, and receive a request to view a property from one or more client access devices of the clients. The request may include location data identifying a location of the client. The request may also or alternatively include a photo of the property. It is noted that the communication devices may transmit the photo to the nearby agents for viewing.

The processors may be configured to identify a set of nearby agents from the agents based on the distance of the agents from the location of the client, and identify a set of available agents from the set of nearby agents based on whether or not the nearby agents propose a showing. Typically, the communication devices will be configured to transmit identification data and location data for these available agents to the client devices.

The communication devices may also be configured to receive a confirmation message identifying one of the available agents from the client devices. The communication device may also transmit identifying information for one or more of the available agents to the client devices, or identifying information for the clients to one or more of the nearby agents. It is noted that the communication devices may also be configured to transmit an alert to the nearby agents upon receipt of the request. This notifies the nearby agents that there is a client requesting a showing nearby.

Various real estate agent and client connection methods are disclosed herein as well. In one exemplary embodiment, a method of connecting a client to one or more real estate agents with a connection system might comprise receiving identification data from a plurality of agents and one or more clients, receiving location data identifying a location of the plurality of agents, and receiving a request to view a property from one or more client access devices. The request may include a location of the clients and at least one photo of the property.

The method may also include, identifying a set of nearby agents from the plurality of agents based on the location of the plurality of agents relative to the location of the clients, receiving a showing proposal from one or more of the nearby agents, and identifying a set of available agents from the set of nearby agents based on whether or not the nearby agents propose a showing. It is noted that the set of nearby agents may be notified of the request via one or more agent access devices.

A client confirmation message may be received from the clients identifying one of the sets of available agents. The identified available agent may then be notified that the identified available agent's showing proposal has been confirmed. An agent confirmation message from the identified available agent might be received as well. In such case, the clients may be notified of the agent confirmation message.

It is noted that identifying information for the available agents may be presented to the clients via a display screen of the client access devices. In addition, identifying information for the clients may be presented to the set of nearby agents via a display screen of one or more agent access devices.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an exemplary connection system;

FIG. 2 is a block diagram illustrating an exemplary connection server;

FIG. 3 is a block diagram illustrating an exemplary access device;

FIG. 4A illustrates an exemplary interface of a client access device;

FIG. 4B illustrates an exemplary interface of a client access device;

FIG. 5A illustrates an exemplary interface of a agent access device;

FIG. 5B illustrates an exemplary interface of a agent access device; and

FIG. 6 is a flow diagram illustrating operation of an exemplary connection system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the connection system herein provides a location-based finder service for real estate agents and their clients. The connection system is advantageous because it allows nearby agents to be quickly and easily located. In addition, the connection system provides a convenient selection process by which agents and clients can quickly find out more about one another to make a fortuitous connection (between agents and clients who may have never met before). In this manner, agent services, such as home showings, can be rapidly and efficiently provided to clients at a moments notice, even in situations where the client unexpectedly sees a property he or she is interested in viewing.

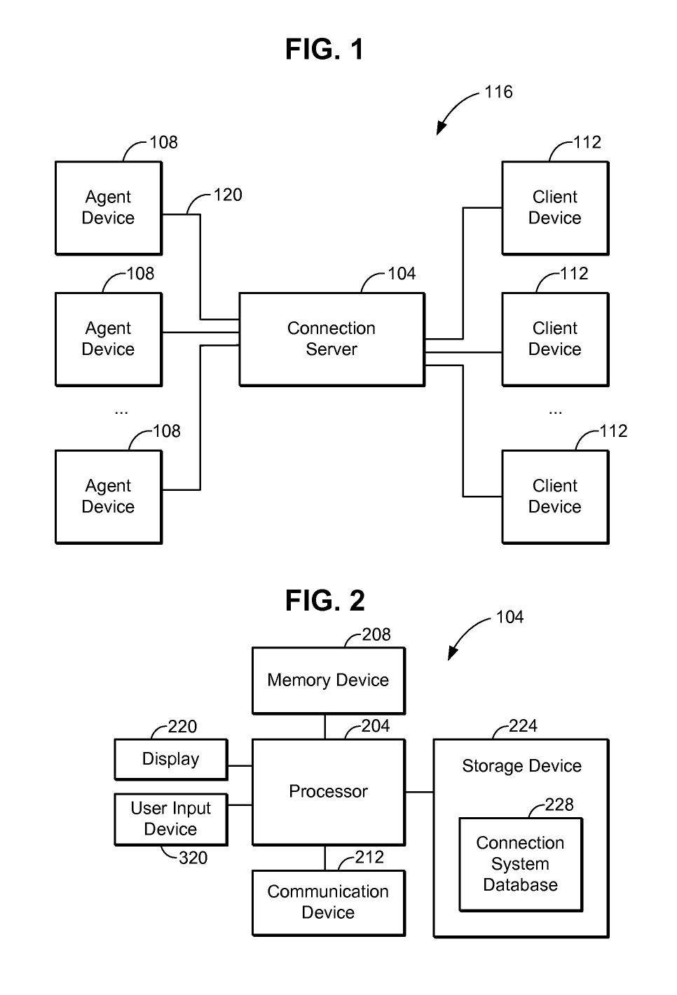

FIG. 1 illustrates an exemplary connection system 116. As can be seen, the connection system 116 may comprise one or more connection servers 104 and one or more access devices 108, 112. In one or more embodiments, there may be distinct types of access devices, such as agent access devices 108 and client access devices 112. In general, the agent access devices 108 will be used by agents, while the client access devices 112 are used by clients.

In operation, various data may be shared between the access devices 108, 112 and the connection server 104. This data may include location data specifying the location of agents and clients (as determined by their respective devices), identification data specifying the identity of an agent or client (e.g., name, address, contact information, username/password), and property data specifying various details or characteristics of a property (e.g., location, photos, size, zoning, type of property). Other data may be communicated as well. For example, data carrying client requests to view a property and agent responses thereto as well as client selections of agents may be communicated between a connection server 104 and access devices 108, 112. In addition, in some embodiments, the connection system may allow communication between agents and clients. As such, text, audio, video, or other communications may be communicated between a connection server 104 and access devices 108, 112 as well.

As can be seen from FIG. 1, one or more communication links 120 may be established by a connection server 104 and access devices 108, 112. It is contemplated that these communication links 120 may be wired or wireless, and that various communication protocols may be used by these communication links. In one or more embodiments, the communication links 120 may provide network connectivity to allow communication across various networks, including LANs, WANs, and the Internet. This permits communication to occur across various distances, vast and small.

It is noted that access devices 108, 112 may communicate directly with one another as well. For example, a communication link 120 may be established (with or without assistance from the connection server 104) between two access devices 108, 112. In this manner, access devices 108, 112 can share property data, identification data, communications, or other data between themselves or via the connection server 104, as will be described further below.

FIG. 2 illustrates an exemplary connection server 104. As can be seen, the connection server 104 may comprise one or more processors 204, memory devices 208, and communication devices 212. In general a processor 204 will be configured to control a connection server 104 to provide the functionality disclosed herein. It is contemplated that a processor 204 may be hardwired with one or more instructions to operate in this manner, or that the processor may execute machine readable code containing one or more instructions to operate in this manner. A processor 204 may be a circuit, microprocessor, CPU, integrated circuit, controller, or the like in one or more embodiments.

A memory device 208 may be used for temporary storage of data during operation of the connection server 104. For example, a memory device 208 may be RAM, cache memory, or the like configured to store data for use by a processor 204 or other component of the connection server. It is contemplated that machine readable code or portions thereof may be stored in a memory device 208 for execution by the processor 204. A memory device 208 may be a separate component or may be integrated into another component, such as a processor 204, in the various embodiments of the connection server 104.

It is noted that various user input devices 216, such as keyboards and mice, may be included in some embodiments to allow a user, such as an administrator or other personnel, to setup, maintain, control, and otherwise interact with the connection server 104. A display device 220 or other output device may be provided as well to provide feedback to the user as he or she is interacting with the connection server 104.

The user input devices 216 and display device 220 (or other output devices) need not be provided in all embodiments as it is contemplated that the connection server 104 may be remotely controlled. For example, a user may interact with the connection server 104 via an external terminal, computer, or the like. In operation, such a terminal, computer, or other control device may communicate with the connection server 104 via a communication device 212 of the connection server.

As alluded to above, a communication device 212 may be configured for wired or wireless communication and utilize various communication protocols to share data with other devices. In one or more embodiments, the communication device 212 may be a network interface to allow access to one or more communication links and/or networks for highly versatile communication with different access devices at various locations.

A storage device 224 accessible to or integrated in the connection server 104 may be included as well. In general, the storage device 224 will provide permanent or more permanent storage of data for use in the connection system. For instance, the storage device 224 may store machine readable code that a processor 204 may retrieve and execute. This data would be preserved in the storage device 224 even if the connection server is rebooted, loses power, or is shut down. It is noted that a storage device 224 may utilize various data storage technologies. For example, a storage device 224 may be configured to retrievably store data on magnetic, optical, flash, or other media. In some embodiments, a storage device 224 may be an external and/or remote device that may be accessible via one or more communication links.

Typically, a storage device 224 will store data used to provide the functionality of the connection system herein. For example, a storage device 224 may store the identification, property, and location described above. In addition, agent/client communications, requests, and/or acceptances thereof may be stored by a storage device 224.

In one or more embodiments, the storage device 224 will store such data in an organized or structured format. For instance, the storage device 224 may utilize a database 228 or other data storage format to store the data. Items of data may be stored in predefined columns, fields, or other storage locations within the database 228. For example, name and/or contact information from the identification data may be stored in corresponding columns of the database 228. It is contemplated that the data may be stored in other structured formats, such as in a flat file or the like.

In operation, data from the database 228 may be retrieved and transmitted to one or more access devices to effectuate operation of the connection system, as will be described further below. In addition, data received from the access devices may be recorded in the database 228 for subsequent use.

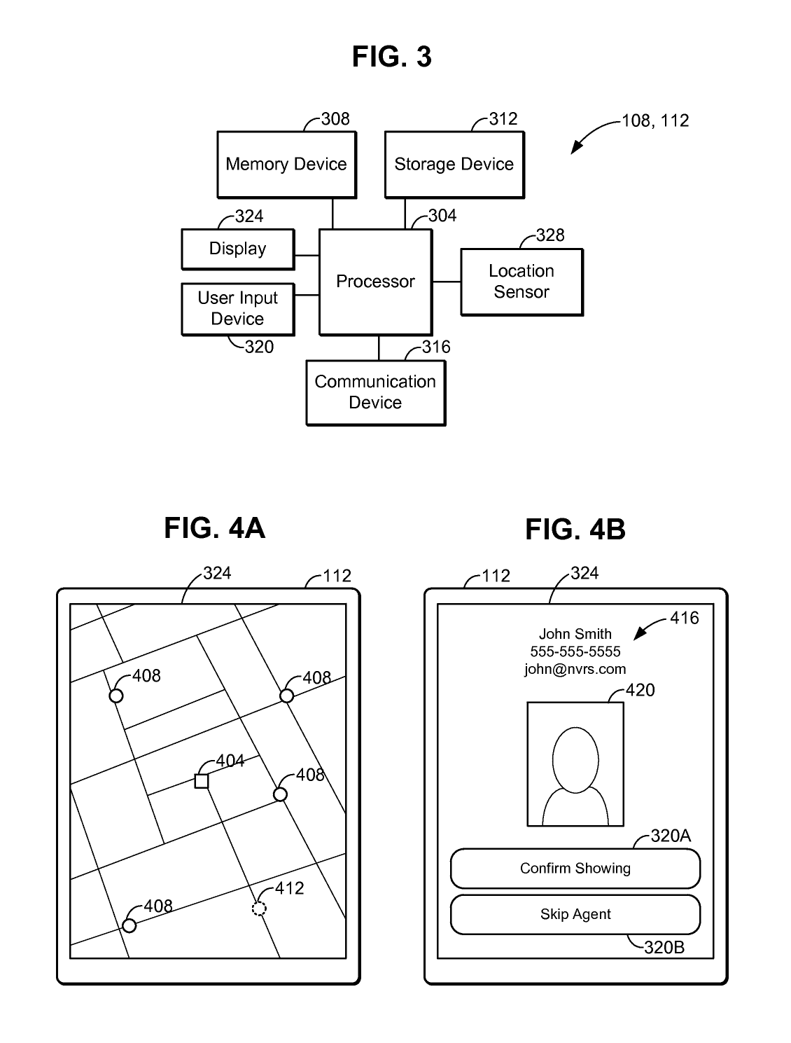

FIG. 3 is a block diagram illustrating an exemplary access device 108, 112. As can be seen an access device 108, 112 may comprise one or more processors 304, memory devices 308, and storage devices 312. Similar to the connection server, an access device's processor 304 may be configured to control the operation of an access device 108, 112, according to one or more instructions. These instructions may be hardwired into a processor 304, or may be embodied in machine readable code executable by the processor. The machine readable code may be stored on a storage device 312 and/or memory device 308 of the access device 108, 112.

Also, similar to above, the storage device 312, such as a hard drive or flash drive, of an access device 108, 112 may be used for permanent or more permanent storage of data, while a memory device 308, such as RAM, may be used for temporary storage. Distinct data may be stored depending on whether an access device 108, 112 is an agent or client access device. For example, and as will be described further below, user interface elements and device functionality will typically be different depending on whether the access device 108, 112 is an agent or client access device.

As can also be seen, an access device 108, 112 may comprise one or more user input devices 320 and one or more output devices, such as the display 324 illustrated in FIG. 3. It is noted that other output devices, such as vibration generators, speakers, and lights may be included in an access device 108, 112 in one or more embodiments. In general, an output device will be used to provide feedback to a user to allow interaction with an access device 108, 112.

A user input device 320 may be configured to accept various forms of user input to allow a user to control or otherwise interact with an access device 108, 112. For example, a user input device 320 may be a touch screen, touch pad, keypad or keyboard in one or more embodiments. Alternatively or in addition a user input device 320 could be a light sensor, camera, microphone, or the like. As will be described further below, a user input device 320 may be used to capture or collect data for use in the connection system. For instance, identification data, property data, property showing requests and acceptances thereof, and agent/client communications may be captured via a user input device 320.

Location data may also be collected via a user input device 320. For instance, an agent or client could manually input a location into an access device 108, 112, such as by inputting coordinates, an address, or other location identifiers into the access device. Typically however, location data will be collected by a location sensor 328 configured to detect or determine the location of the access device 108, 112. Various location sensing technologies may be used. For example, the location sensor 328 may be a GPS device, a WiFi radio, cellular radio, or other device configured to determine or allow determination of an access device's current location.

Location, identification, property, and other data (such as request/acceptance and communications data) may be communicated with a connection server and/or other access devices 108, 112 via a communication device 316, such as shown in FIG. 3. Similar to the connection server, an access device's communication device 316 may be configured to provide wired or wireless communication links utilizing various communication protocols.

FIGS. 4A-4B illustrate operation and elements of an exemplary client access device. As can be seen, exemplary user interface screens are illustrated in FIGS. 4A-4B. These screens may be presented by a client access device 112 during operation of the connection system. It is noted that other user interface screens may be presented during operation of the connection system. For example, a registration screen for collecting identification data from clients may be used by a client to sign up for the connection system. To illustrate, a client may input his or her name, email, address, phone number, a username and password, or other identification data to sign up. The identification data may include one or more photos of the client as well.

Referring to FIG. 4A, it can be seen that a client access device 112 may display location data for the client 404 and one or more agents 408, 412. As can also be seen, only available agents 408 within a predefined vicinity of a client 404 may be presented. Location data identifying the location of agents 408, 412 may be tracked and provided by a connection server of the connection system.

In the embodiment of FIG. 4A two types of agents 408, 412 are presented, however it is noted that in typically embodiments only available agents 408, which are those who are available to show a home will be displayed. In such embodiments, unavailable agents 412 that have been identified as unavailable would not be shown. As will be described below, agents 408, 412 may identify themselves as available or unavailable, such as by accepting or declining a client's request for a property showing.

As can be seen, a number of agents 408, 412 (available or otherwise) may be presented to allow a client to select one to conduct a property showing. As will be described in the following, the client may first view additional information about the agents 408, 412 before choosing one to conduct the property showing. This is advantageous in that it permits the client to evaluate each agent 408, 412 to choose the best agent for his or her needs. For example, some agents may be experts on particular types of property, speak certain languages, be familiar with the neighborhood, or have other skills or attributes that would benefit a particular client. The client access device 112 allows this information to be viewed to allow an informed selection of an agent by a client.

Referring to FIG. 4B, it can be seen that identification data for agents may be retrieved by a client with his or her client access device 112. For example, the client may select available agents 408 to display further information relating to the agent. In the example of FIG. 4B, it can be seen that the identification data 416, including any optional photos 420, for the selected agent is displayed upon selection of the agent. In one or more embodiments, only available agents 408 may be selected.

FIG. 4B also shows that the client may accept or confirm that he or she wishes the selected available agent to show the desired property. A user input, such as the “Confirm” button 320A or the like, such as shown in FIG. 4B, may be used to collect the client's confirmation. If the client does not wish to work with the current selected agent, he or she may engage a “Skip” button 320B or the like and then select another available agent. It is noted that additional information about an agent may be displayed in addition to the identification data. For example, professional experiences and the like may be displayed to assist a client in deciding whether or not to work with the currently selected agent.

If a confirmation is given, the client access device 112 may be configured to receive or transmit communication with the selected agent. As stated, this communication may occur via text, video, audio, or various combinations thereof. In addition, it is contemplated that, once confirmed, real time location data showing the location of the selected agent may be presented to the client, such as via a map like that of FIG. 4A. Also, an estimated time of arrival may be provided. This estimate may be provided by the agent or be determined by the connection system based on the relative location of the selected agent to the client.

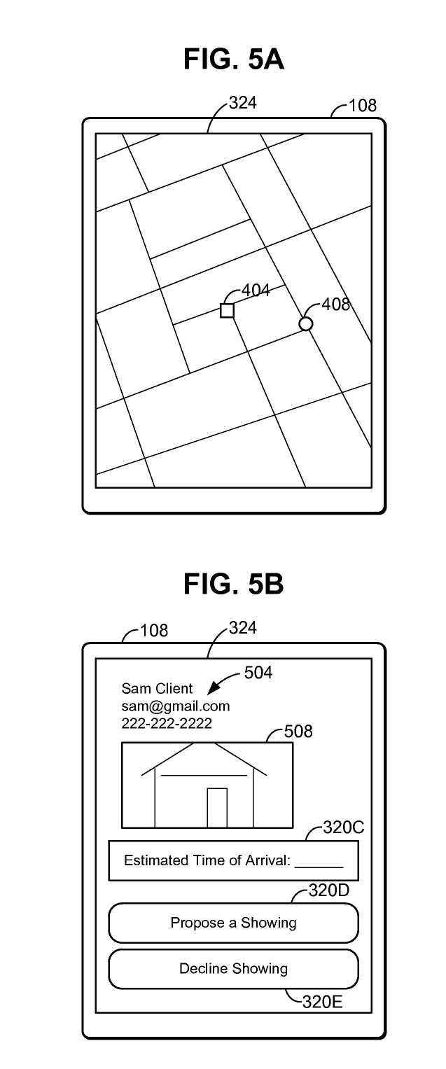

FIGS. 5A-5B illustrate operation and elements of an exemplary agent access device 108 via exemplary user interface screens that may be presented on an agent access device. In FIG. 5A, it can be seen that location data for the client 404 may be presented so that an agent 408 may decide whether or not to propose a showing, and by doing so indicate that the agent is available. As can also be seen, the agent 408 can discern the location and distance of the client 404 via the map presentation provided by the agent access device 108 to make this determination. The client's location data may be tracked and provided from a connection server of the connection system.

FIG. 5B illustrates an interface screen where an agent may view additional details regarding the client. For example, the client's identification data 504 may be shown to the agent. In addition or alternatively property data 508 may be shown to allow the agent to see the property the client wishes to view. In one or more embodiments, the agent may propose a showing by engaging a “Propose” button 320D or the like. If the agent does not wish to show the property, he or she may engage the “Decline” button 320E. In some embodiments, as described above, the agent may provide an estimated time of arrival via an input field 320C designated for such data entry. Thereafter, once the “Propose” button 320D is engaged, the estimated time of arrival may be transmitted to the client. The client may utilize the estimated time of arrival to decide whether or not to confirm a property showing by this agent. For example, the client may skip agents that are too far away if desired.

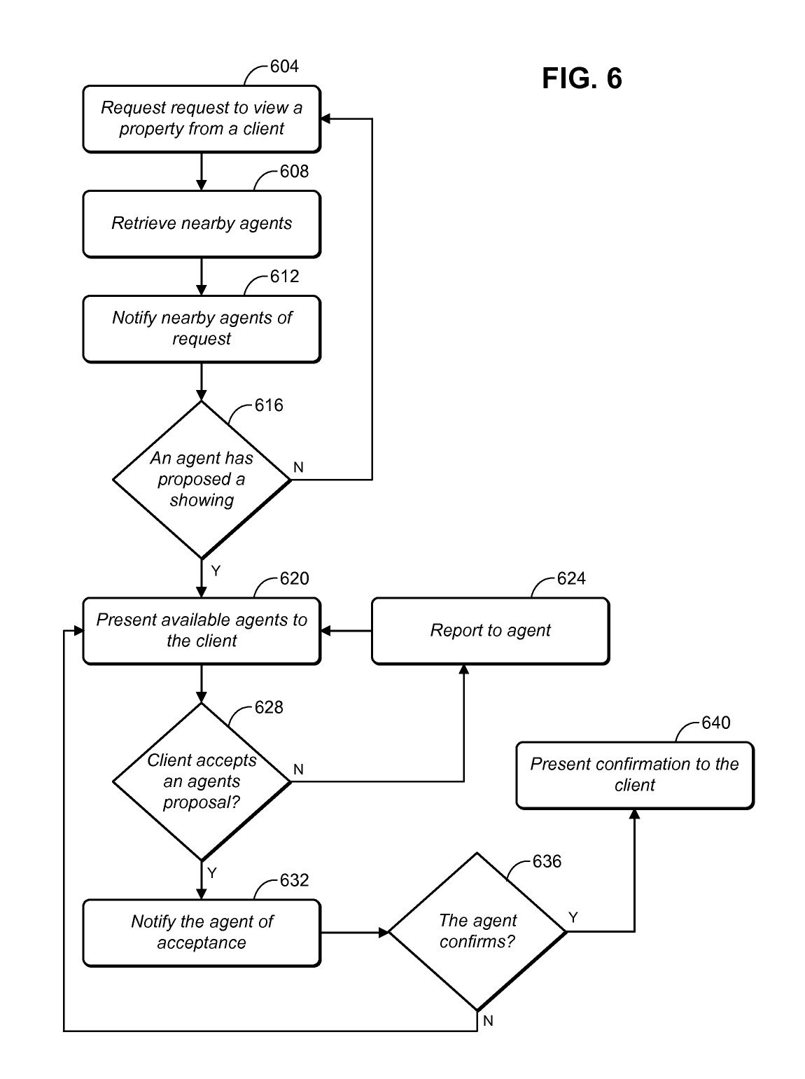

FIG. 6 is a flow diagram illustrating operation of an exemplary connection system. At a step 604, a request for a showing from a client access device may be received at a connection server. The request may include information that identifies the client requesting the showing (i.e., identification data), his or her location (i.e., location data), and information about the property (i.e., property data). The property data may include one or more photos of the property. It is noted that a photo of the property may be taken with the client access device. In some embodiments, a photo may be required to complete a request for a showing.

At a step 608, the connection server may retrieve a set of nearby agents, such as from the server's storage device. Nearby agents may be those within a predefined distance or vicinity of the client. It is noted that this distance may be variable. For instance, the predefined distance may increase if no agents are in the immediate vicinity of the client.

As stated above, agent access devices may periodically or continuously report location data to the connection server to allow agents' locations to be updated by the connection server. In some embodiments, agents may manually initiate reporting of location data from their agent access devices to the server, such as by logging or checking in with the connection server. The agents' location data can then be used to identify the agents that are near the client.

The nearby agents may be notified that a client in their area wishes to view a property at a step 612. This may occur in various ways. For example, the connection server may transmit a notification or alert to the nearby agents' agent access devices. These devices may in turn notify or alert their associated agents. An alert message or the like may be presented to provide this notification or alert to the agents. In addition or alternatively, a user interface screen such as that of FIG. 5A or 5B may be displayed as part of the notification or alert. The agent may then indicate whether or not he or she wishes to propose a showing.

At a decision step 616, it may be determined if one or more of the agents have proposed a showing. The proposal for a showing indicates that the agent is available to the client. If the agents decline or do not respond within a predefined time limit, the connection server may return to step 604 and await additional requests for showings.

If one or more agents have proposed a showing, these agents may be presented on the client's client access device as available agents, such as shown in FIG. 4A. As the client selects various agents, their identification and other data, such as shown in FIG. 4B, may retrieved from the connection server and displayed via the client's client access device.

At a decision step 628, it may be determined if the client has accepted or confirmed a proposed showing from an available agent. In operation, if the client confirms a proposed showing, the client access device may transmit a client confirmation message to the connection server. If the client skips an agent (i.e., declines their proposed showing), a message that the agent has been skipped may be transmitted to the connection server as well. The connection server may also determine that the agent has been skipped if the client fails to select an agent within a predefined time limit.

If an agent's showing is skipped, the connection server may report the same to the client at a step 624. If an agent's showing is confirmed, the connection server may report the confirmation/acceptance to the client at a step 632. A message or the like may be displayed on the agent access device indicating whether or not the agent's showing has been skipped or confirmed.

The agent may be provided an opportunity to confirm the showing as well. This ensures that the agent is available to show the property. This confirmation may occur at a decision step 636. In operation, the agent may transmit an agent confirmation message from his or her agent access device to the connection server. Confirmation may also or alternatively require the agent to call, text, or otherwise communicate directly with the client in some embodiments. This communication allows further details to be exchanged between the client and agent, such as a specific meeting location for the showing (which may or may not be at the property's location).

If confirmed, a confirmation message may be presented on the client access device at a step 640. If declined or the agent does not confirm within a predefined time limit, the client may be notified of the same. The client may then select another agent at step 620. The connection process may then continue from step 620 as described above.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A real estate agent and client connection system comprising:
one or more agent access devices configured to determine and transmit the location of one or more real estate agents;
a client access device configured to transmit one or more requests to view a property, the request including location data specifying the location of a client and property data describing the property; and
a connection server configured to:
store identification data for the one or more real estate agents and the client;
store property data received from the client access device;
maintain an updated record of the location data of the one or more real estate agents;
in response to the one or more requests, transmit identification data identifying one or more nearby agents based on the location of the one or more real estate agents relative to the location of the client, wherein the one or more nearby agents are displayed on a display screen of the client access device;
receive a showing proposal from one or more of the one or more nearby agents identifying those one or more nearby agents as available agents;
receive a client confirmation from the client access devices identifying one of the one or more available agents.

2. The real estate agent and client connection system of claim 1, wherein the connection server is further configured to receive an agent confirmation from the identified available agent.

3. The real estate agent and client connection system of claim 1, wherein the property data includes a photo of the property.

4. The real estate agent and client connection system of claim 1, wherein the client access device is configured to retrieve from the connection server and display identification information associated with the one or more available agents.

5. The real estate agent and client connection system of claim 1, wherein the client access device is configured to retrieve location data identifying the location of the one or more available agents from the connection server and to display the retrieved location data on a map.

6. The real estate agent and client connection system of claim 1, wherein the one or more agent access devices are configured to retrieve at least some of the property data from the connection server and to present the retrieved property data to the one or more nearby agents.

7. The real estate agent and client connection system of claim 1, wherein the one or more agent access devices are configured to retrieve location data identifying the location of the client from the connection server and to display the retrieved location data on a map.

8. The real estate agent and client connection system of claim 1, wherein the one or more agent access devices are configured to retrieve identification data about the client from the connection server and to display the retrieved identification data to the one or more nearby agents.

9. A connection server comprising:
one or more storage devices configured to store identification data for one or more agents and one or more clients, and property data;
one or more communication devices configured to:
receive location data identifying a location of the one or more agents; and
receive a request to view a property from one or more client access devices of the one or more clients, the request including location data identifying a location of the client; and
one or more processors configured to:
identify a set of nearby agents from the one or more agents based on the distance of the one or more agents from the location of the client; and
identify a set of available agents from the set of nearby agents based on whether or not the nearby agents propose a showing;
wherein the one or more communication devices transmit identification data and location data for the available agents to the one or more client devices.

10. The connection server of claim 9, wherein the request includes a photo of the property.

11. The connection server of claim 10, wherein the one or more communication devices are configured to transmit the photo to the set of nearby agents.

12. The connection server of claim 9, wherein the one or more communication devices are configured to receive a confirmation message from the one or more client devices, the confirmation message identifying one of the available agents.

13. The connection server of claim 9, wherein the one or more communication device are configured to transmit identifying information for one or more of the available agents to the one or more client devices.

14. The connection server of claim 9, wherein the one or more communication devices are configured to transmit identifying information for the one or more clients to one or more of the nearby agents.

15. The connection server of claim 9, wherein the one or more communication devices are configured to transmit an alert to the nearby agents upon receipt of the request.

16. A method of connecting a client to one or more real estate agents with a connection system comprising:
receiving identification data from a plurality of agents and one or more clients;
receiving location data identifying a location of the plurality of agents;
receiving a request to view a property from one or more client access devices, the request including a location of the one or more clients and at least one photo of the property;
identifying a set of nearby agents from the plurality of agents based on the location of the plurality of agents relative to the location of the one or more clients;
receiving a showing proposal from one or more of the nearby agents;
identifying a set of available agents from the set of nearby agents based on whether or not the nearby agents propose a showing;
receiving a client confirmation message from the one or more clients identifying one of the set of available agents;
notifying the identified available agent that the identified available agent's showing proposal has been confirmed.

17. The method of claim 16 further comprising receiving an agent confirmation message from the identified available agent and notifying the one or more clients of the agent confirmation message.

18. The method of claim 16 further comprising presenting identifying information for the available agents to the one or more clients via a display screen of the one or more client access devices.

19. The method of claim 16 further comprising presenting identifying information for the one or more clients to the set of nearby agents via a display screen of one or more agent access devices.

20. The method of claim 16 further comprising notifying the set of nearby agents of the request via one or more agent access devices.
